(19) United States
(12) Patent Application Publication
(10) Pub. No.: US 2013/0202807 A1
(43) Pub. Date: Aug. 8, 2013

(54) METHOD FOR PRODUCING A COLOUR- AND/OR EFFECT-PRODUCING MULTILAYER COATING

(71) Applicant: Bernhard Steinmetz, Rutschenhausen (DE)

(72) Inventor: Bernhard Steinmetz, Rutschenhausen (DE)

(73) Assignee: BASF COATINGS GMBH, Munster (DE)

(21) Appl. No.: 13/636,756

(22) PCT Filed: Mar. 24, 2011
(86) PCT No.: PCT/EP2011/054563

§ 371 Date: Oct. 5, 2012

(30) Foreign Application Priority Data
Mar. 24, 2010 (DE) 10 2010 012 449.4

(51) Int. Cl. C09D 5/29

(52) U.S. Cl. CPC C09D 5/29
USPC 427/514; 524/543; 427/385.5

(57) ABSTRACT

The present invention relates to a method for producing a multicoat color and/or effect paint system, the method comprising (1) applying a pigmented aqueous basecoat to a substrate, the basecoat comprising from 0.1% to 5% by weight, based on the total weight of the basecoat, of at least one vinyl ether of the general formula R—O—CH═CH₂ where R is an unsubstituted or substituted organic radical selected from the group consisting of alkyl, cycloalkyl, aryl, and alkaryl radicals having 4 to 18 carbon atoms, (2) forming a basecoat film from the coating applied in stage (1), (3) applying a clearcoat to the basecoat film, and then (4) curing the basecoat film together with the clearcoat.

The invention relates to a method for producing a multicoat color and/or effect paint system, by

(1) applying a pigmented aqueous basecoat to a substrate,

(2) forming a polymer film from the coating applied in stage (1),

(3) applying a clearcoat to the resultant basecoat film, and then

(4) curing the basecoat film together with the clearcoat film,

The invention also relates to pigmented aqueous basecoat materials suitable for producing multicoat color and/or effect paint systems.

The method described above is known (cf., for example, German patent application DE 199 48 004 A1, page 17 line 37 to page 19 line 22, or German patent DE 100 43 405 C1, column 3 paragraph [0018], and column 8 paragraph [0052], to column 9 paragraph [0057], in conjunction with column 6 paragraph [0039], to column 8 paragraph [0050]), and is in extensive use, for example, for both the OEM finishing (original finishing) and the refinishing of automobile bodies.

The method in question, referred to as the basecoat/clearcoat method, proceeds via a wet-on-wet process to give multicoat color and/or effect paint systems, which are in need of improvement particularly as regards the incidence of pinholes, which are visible as very small holes in clearcoat and basecoat film.

The objective on which the present invention is based is therefore that of providing a method of the type described above, with which multicoat color and/or effect paint systems are obtainable that are improved over the paint systems of the prior art. The paint systems ought in particular to have no or only very few pinholes, and/or an increased pinholing limit. The pinholing limit is that dry basecoat film thickness above which pinholes occur.

This object is achieved, surprisingly, by using in stage (1) of the basecoat/clearcoat method described above a pigmented aqueous basecoat which comprises at least one vinyl ether of the general formula R—O—CH═CH₂ where R is an unsubstituted or substituted organic radical selected from the group consisting of alkyl, cycloalkyl, aryl, and alkaryl radicals having 4 to 18 carbon atoms, and where the vinyl ether content of the basecoat is 0.1% to 5% by weight, based on the total weight of the basecoat.

The invention also provides the above-described, pigmented aqueous coatings that can be used in stage (1) of the basecoat/clearcoat method.

In stage (1) of the method of the invention it is possible in principle to use all known aqueous basecoats provided they contain at least one of the above-defined vinyl ethers in an amount of 0.1% to 5% by weight, based on the total weight of the basecoat. Basecoats are termed aqueous when they contain 30% to 70% by weight of water, based on the total weight of the basecoat. The terms “aqueous basecoat” and “waterborne basecoat” are used in this specification as synonymous terms.

The basecoats used in accordance with the invention comprise color and/or effect pigments.

In the method of the invention it is preferred to use basecoats which as binders comprise binders curable physically, thermally, or both thermally and with actinic radiation. With particular preference there is at least one saturated or unsaturated polyurethane resin binder present. Coatings of this kind comprising polyurethane resin may likewise typically be cured physically, thermally, or both thermally and with actinic radiation.

In the context of the present invention the term “physical curing” denotes the formation of a film through loss of solvent from polymer solutions or polymer dispersions. Normally no crosslinking agents are needed for this process.

In the context of the present invention the term “thermal curing” denotes the heat-initiated crosslinking of a coating film, for which either a separately present crosslinking agent and/or self-crosslinking binders is or are employed. The crosslinking agent comprises reactive functional groups which are complementary to the reactive functional groups present in the binders. This is typically referred to by those in the art as external crosslinking. Where the complementary reactive functional groups or autoreactive functional groups, i.e., groups which react “with themselves”, are already present in the binder molecules, the binders are self-crosslinking. Examples of suitable complementary reactive functional groups and autoreactive functional groups are known from German patent application DE 199 30 665 A1, page 7 line 28 to page 9 line 24.

In the context of the present invention, actinic radiation means electromagnetic radiation such as near infrared (NIR), visible light, UV radiation, X-rays or y radiation, more particularly UV radiation, and particulate radiation such as electron beams, beta radiation, alpha radiation, proton beams or neutron beams, more particularly electron beams. Curing by UV radiation is typically initiated by free-radical or cationic photoinitiators.

Where thermal curing and actinic-light curing are employed jointly, the term “dual cure” is also used.

In the present invention, preference is given to basecoats which are curable thermally or both thermally and with actinic radiation—by means of dual cure. Particularly preferred are those which as binder comprise a polyurethane resin and as crosslinking agent comprise an amino resin or a blocked or nonblocked polyisocyanate. Among the amino resins, melamine resins are preferred in particular.

Suitable saturated or unsaturated polyurethane resins are described, for example, in
German patent application DE 199 11 498 A1, column 1 lines 29 to 49 and column 4 line 23 to column 11 line 5,
German patent application DE 199 48 004 A1, page 4 line 19 to page 13 line 48,
European patent application EP 0 228 003 A1, page 3 line 24 to page 5 line 40,
European patent application EP 0 634 431 A1, page 3 line 38 to page 8 line 9, or
international patent application WO 92/15405, page 2 line 35 to page 10 line 32.

The polyurethane resins contain for stabilization preferably either
functional groups which can be converted into cations by neutralizing agents and/or quaternizing agents, and/or cationic groups, or
functional groups which can be converted into anions by neutralizing agents, and/or anionic groups, and/or
nonionic hydrophilic groups.

The polyurethane resins are linear or contain branches. They may also take the form of graft polymers. In that case they are grafted preferably with acrylate groups. The acrylate groups in question are preferably introduced into the polymer by preparation of a primary polyurethane dispersion.

Such graft polymers are known well to the skilled worker and are described in DE 199 48 004 A1, for example.

JP 07-224130 A describes similar unsaturated polymers, namely polyesters and polyester urethanes for coating material compositions, to which vinyl ethers are attached via hydroxyl or glycidyloxy groups.

If the basecoats preferably employed are present in the form of self-crosslinking systems, then the polyurethane resin content is 50% to 100%, preferably 50% to 90%, and more preferably 50% to 80%, by weight, based on the film-forming solids of the basecoat.

By film-forming solids is meant the nonvolatile weight fraction of the coating material, excluding pigments and/or fillers, which remains as a residue after drying at 120° C. for two hours.

In the case of externally crosslinking systems, the polyurethane resin content is between 10% and 80%, preferably between 15% and 75%, and more preferably between 20% and 70%, by weight, based in each case on the film-forming solids of the basecoat.

It is essential to the invention that the aqueous basecoats used in stage (1) of the method of the invention comprise at least one vinyl ether of the general formula R—O—CH═CH₂ where R is an unsubstituted or substituted alkyl, cycloalkyl, aryl or alkaryl radical having 4 to 18 carbon atoms, more preferably an alkyl or cycloalkyl radical having 4 to 16 carbon atoms, such as, more particularly, an n-butyl, isobutyl, tert-butyl, 2-ethylhexyl, dodecyl or cyclohexyl radical, and that the vinyl ether content of the basecoats is 0.1% to 5%, preferably 0.1% to 4%, more preferably 0.2% to 3%, and very preferably 0.5% to 2.5%, by weight, based on the total weight of the basecoat. If the vinyl ether content is below 0.1% by weight, the object on which the invention is based is not achieved. If the amount is more than 5% by weight, there may in certain circumstances be disadvantages to be accepted, such as a deterioration in adhesion in the case of underbaked systems, for example. Examples of suitable substituents on the radical R include hydroxyl radicals.

If R is an alkyl radical, it may be branched or unbranched.

Vinyl ethers used with particular preference are as follows: n-butyl vinyl ether, tert-butyl vinyl ether, 2-ethylhexyl vinyl ether, dodecyl vinyl ether, and cyclohexyl vinyl ether.

The basecoats used in accordance with the invention may further comprise at least one additive. Examples of such additives are salts which can be decomposed thermally without residue, or substantially without residue, crosslinking agents such as the aforementioned amino resins and blocked or nonblocked polyisocyanates, organic solvents, reactive diluents, transparent pigments, fillers, molecularly dispersively soluble dyes, nanoparticles, light stabilizers, antioxidants, deaerating agents, emulsifiers, slip additives, polymerization inhibitors, free-radical polymerization initiators, adhesion promoters, flow control agents, film-forming auxiliaries, sag control agents (SCAs), flame retardants, corrosion inhibitors, waxes, siccatives, biocides, matting agents, and thickeners. Suitable thickeners include inorganic thickeners from the phyllosilicate groups. Besides the inorganic thickeners, however, it is also possible for one or more organic thickeners to be used. They are preferably selected from the group consisting of (meth)acrylic acid-(meth)acrylate copolymer thickeners, such as, for example, the commercial product Viscalex HV30 (Ciba, BASF), and polyurethane thickeners, such as, for example, the commercial product DSX® 1550 from Cognis. (Meth)acrylic acid-(meth)acrylate copolymer thickeners are those which as well as acrylic acid and/or methacrylic acid also comprise in copolymerized form one or more acrylic esters (i.e., acrylates) and/or one or more methacrylic esters (i.e., methacrylates). Common to the (meth)acrylic acid-(meth)acrylate copolymer thickeners is that in an alkaline medium, in other words at pH levels >7, more particularly >7.5, the formation of salts of the acrylic acid and/or methacrylic acid, in other words the formation of carboxylate groups, causes them to exhibit a sharp increase in viscosity. Where (meth)acrylic esters are used that are formed from (meth)acrylic acid and a C₁-C₆-alkanol, the products are substantially nonassociative (meth)acrylic acid-(meth)acrylate copolymer thickeners, such as, for example, the aforementioned Viscalex HV30. Substantially nonassociative (meth)acrylic acid-(meth)acrylate copolymer thickeners are also identified in the literature as ASE thickeners (for “Alkali Soluble/Swellable Emulsion or dispersion”. Also suitable for use as (meth)acrylic acid-(meth)acrylate copolymer thickeners, however, are those known as HASE thickeners (“Hydrophobically Modified Anionic Soluble Emulsions”, or dispersions). They are obtained by using, in addition to or instead of the C₁-C₆-alkanols, alkanols having a larger number of carbon atoms, 7 to 30 for example, or 8 to 20 carbon atoms. HASE thickeners are substantially associative in terms of their thickening action. On account of their thickening properties, the (meth)acrylic acid-(meth)acrylate copolymer thickeners that can be used are unsuitable as binder resins, and hence are not included among the physically, thermally, or both thermally and actinically curable binders that are referred to as binders, and are therefore explicitly different from the poly(meth)acrylate-based binders which can be used in the basecoat compositions of the invention. By polyurethane thickeners are meant the associative thickeners referred to in the literature as HEUR (Hydrophobically Modified Ethylene Oxide Urethane Rheology Modifiers). In chemical terms these are nonionic, branched or unbranched block copolymers composed of polyethylene oxide chains (and in some cases polypropylene oxide chains) which are linked to one another via urethane bonds and which carry terminal long-chain alkyl or alkylene groups having 8 to 30 carbon atoms. An example of typical alkyl groups are dodecyl or stearyl groups; an example of a typical alkenyl group is an oleyl group; a typical aryl group is the phenyl group; and an example of the typical alkylated aryl group is a nonylphenyl group. On account of their thickening properties and structure, the polyurethane thickeners are not suitable as physically, thermally, or both thermally and physically curable binder resins. They are therefore explicitly different from the polyurethanes which can be used as binders in the basecoat compositions of the invention.

Suitable additives of the aforementioned kind are known, for example, from
German patent application DE 199 48 004 A1, page 14 line 4 to page 17 line 5,
German patent DE 100 43 405 C1, column 5 paragraphs [0031] to [0033].

They are used in the customary and known amounts.

The solids content of the basecoats used in accordance with the invention may vary according to the requirements of the case in hand. The solids content is guided primarily by the viscosity that is required for application, more particularly spray application, and hence may be adjusted by the skilled worker on the basis of his or her general art knowledge, where appropriate with the assistance of a few range finding tests.

The solids content of the basecoats is preferably 5% to 70%, more preferably 10% to 65%, and with particular preference 15% to 60%, by weight.

The solids content means that weight fraction which remains as a residue on evaporation under defined conditions. In the present specification, the solids has been determined in accordance with DIN EN ISO 3251. The measurement duration was 60 minutes at 125° C.

The basecoats used in accordance with the invention can be produced using the mixing assemblies and mixing methods that are customary and known for preparing basecoats.

The basecoats of the invention can be employed as one-component (1K), two-component (2K) or multicomponent (3K, 4K) systems.

In one-component (1K) systems, binder and crosslinking agent are present alongside one another, i.e., in one component. A prerequisite for this is that the two constituents crosslink with one another only at relatively high temperatures and/or on exposure to actinic radiation.

In two-component (2K) systems, binder and crosslinking agent are present separately from one another in at least two components, which are combined not until shortly before application. This form is selected when binder and crosslinking agent react with one another even at room temperature. Coatings of this kind are employed in particular to coat heat-sensitive substrates, particularly in automotive refinish.

The method of the invention can be used to coat metallic and nonmetallic substrates, more particularly plastics substrate, preferably automobile bodies or parts thereof.

The invention also provides for the use of the vinyl ethers used in the basecoats of the invention to increase the pinholing limit and/or to reduce the number of pinholes in aqueous pigmented coatings.

The invention is illustrated below by examples.

### EXAMPLES

### 1. Preparation of a Silver Waterborne Basecoat 1

The components listed under “aqueous phase” in table A are stirred together in the order stated to form an aqueous mixture. In the next step, an organic mixture is prepared from the components listed under “organic phase”. The organic mixture is added to the aqueous mixture. The system is then stirred for 10 minutes and adjusted using deionized water and dimethanolamine to a pH of 8 and a spray viscosity of 58 mPas under a shearing load of 1000/sec, as measured using a rotational viscosimeter (Rheomat RM 180 instrument from Mettler-Toledo) at 23° C.

TABLE A

| | parts by |
|---|---|
| Component | weight |
| Aqueous phase | |
| 3% strength Na Mg phyllosilicate solution | 26 |
| Deionized water | 3 |
| Butyl glycol | 1.75 |
| Polyurethane acrylate; prepared according to page 7 line 55- | 4.5 |
| page 8 line 23 of DE-A-4437535 | |
| 20.5% strength by weight solution of DSX 1550 (Cognis), | 0.6 |
| rheological agent | |
| Polyester; prepared according to example D, column 16 lines | 3.2 |
| 37-59 of DE-A-4009858 | |
| Tensid S (BASF), surfactant | 0.3 |
| Butyl glycol | 0.55 |
| Cymel 203; melamine-formaldehyde resin, available from | 4.1 |
| Cytec | |
| 10% strength dimethylethanolamine in water | 0.3 |
| Deionized water | 6 |
| Polyurethane acrylate; prepared according to page 19 line | 20.4 |
| 44-page 20 line 7 of DE-A-1998004 | |
| Surfynol ® 104 from Air Products (52% form) surfactant | 1.6 |
| Butyl glycol | 0.5 |
| 3% strength by weight aqueous Viscalex HV 30 solution; | 3.9 |
| rheological agent, available from BASF, in water | |
| Organic phase | |
| Mixture of two commercial aluminum pigments, obtainable | 6.2 |
| from Altana-Eckart | |
| Butyl glycol | 7.5 |
| Polyester; prepared according to example D, column 16 lines | 5 |
| 37-59 of DE-A-4009858 | |

### Waterborne Basecoat 12:

Inventive waterborne basecoat 12 was prepared by adding 1.5 parts by weight of commercially available dodecyl vinyl ether to waterborne basecoat 1.

### Waterborne Basecoat 13:

Inventive waterborne basecoat 13 was prepared by adding 1.5 parts by weight of commercially available tert-butyl vinyl ether to waterborne basecoat 1.

### Waterborne Basecoat 14:

Inventive waterborne basecoat 14 was prepared by adding 1.5 parts by weight of commercially available n-butyl vinyl ether to waterborne basecoat 1.

### Waterborne Basecoat 15:

Inventive waterborne basecoat 15 was prepared by adding 1.5 parts by weight of commercially available 2-ethylhexyl vinyl ether to waterborne basecoat 1.

### Waterborne Basecoat 16:

Inventive waterborne basecoat 16 was prepared by adding 1.5 parts by weight of commercially available cyclohexyl vinyl ether to waterborne basecoat 1.

### Waterborne Basecoat 17:

Inventive waterborne basecoat 17 was prepared by adding 1.5 parts by weight of commercially available octadecyl vinyl ether to waterborne basecoat 1.

TABLE 1
Compositions of waterborne basecoats (WBC) 1 and I2-I7

| WBC | [% by weight] | Vinyl ether |
|---|---|---|
| 1 | — | — |
| I2 | 1.5 | dodecyl vinyl ether |
| I3 | 1.5 | tert-butyl vinyl ether |
| I4 | 1.5 | n-butyl vinyl ether |
| I5 | 1.5 | 2-ethylhexyl vinyl ether |
| I6 | 1.5 | cyclohexyl vinyl ether |
| I7 | 1.5 | octadecyl vinyl ether |

The weight percent figures in table 1 relate to the fraction of the vinyl ether in each waterborne basecoat.

### Comparative Experiment Between Waterborne Basecoat 1 and Waterborne Basecoats 12 to 17

For determination of the pinholing limit and the pinhole count, the multicoat paint systems were produced in accordance with the following general instructions:

A steel panel coated with a filler paint system and with dimensions of 30×50 cm was provided on one long edge with an adhesive strip, to allow the differences in film thickness to be determined after coating had taken place. The waterborne basecoat was applied electrostatically in wedge form. The resulting waterborne basecoat film was flashed off at room temperature for one minute and then dried in a forced-air oven at 70° C. for 10 minutes. Over the dried waterborne basecoat film, a customary two-component clearcoat was applied. The resulting clearcoat film was flashed off at room temperature for 20 minutes. Then the waterborne basecoat film and the clearcoat film were cured in a forced-air oven at 140° C. for 20 minutes. Following visual evaluation of the pinholes in the resulting wedge-shaped multicoat paint system, the film thickness of the pinholing limit was ascertained. The results are given in table 2.

TABLE 2
Pinholing limit and pinhole count of waterborne basecoat 1 and of
waterborne basecoats I2 to I7

| WBC | Pinholing limit (μm) | Pinhole count |
|---|---|---|
| 1 | 12 | 107 |
| I2 | 26 | 5 |
| I3 | 25 | 27 |
| I4 | 21 | 5 |
| I5 | 33 | 6 |
| I6 | 30 | 12 |
| I7 | 15 | 36 |

The results emphasize the fact that the inventive use of vinyl ethers significantly raises the pinholing limit in comparison to waterborne basecoat 1, and at the same time significantly lowers the pinhole count.

1. A method for producing a multicoat color and/or effect paint system, the method comprising
(1) applying a pigmented aqueous basecoat to a substrate, the pigmented aqueous basecoat comprising from 0.1% to 5% by weight, based on the total weight of the basecoat, of at least one vinyl ether of the general formula R—O—CH═CH₂ where R is an unsubstituted or substituted organic radical selected from the group consisting of alkyl, cycloalkyl, aryl, and alkaryl radicals having 4 to 18 carbon atoms,
(2) forming a basecoat film from the coating applied in stage (1),
(3) applying a clearcoat to the basecoat film, and then
(4) curing the basecoat film together with the clearcoat.

2. The method claim 1, wherein R is a radical having 4 to 18 carbon atoms selected from the group consisting of an unsubstituted alkyl radical, an unsubstituted cyclolalkyl radical, a substituted alkyl radical, or a substituted cycloalkyl radical.

3. The method of claim 1, wherein R is a radical selected from the group consisting of an n-butyl radical, an isobutyl radical, a tert-butyl radical, a 2-ethylhexyl radical, a dodecyl radical or a cyclohexyl radical.

4. The method of claim 1, wherein the vinyl ether content of the pigmented aqueous basecoat used in stage (1) is 0.2% to 3% by weight, based on the total weight of the basecoat.

5. The method of claim 1, wherein the pigmented aqueous basecoat comprises a binder comprising at least one saturated or unsaturated polyurethane resin.

6. The method of claim 1, wherein the pigmented aqueous basecoat is curable thermally or both thermally and with actinic radiation.

7. The method of claim 6, wherein the pigmented aqueous basecoat comprises at least one crosslinking agent from the group consisting of amino resin, blocked polyisocyanates, or nonblocked polyisocyanates.

8. A pigmented aqueous coating comprising between 0.1 and 5% by weight, based on the total weight of the coating, of at least one vinyl ether of the general formula R—O—CH═CH₂ where R is an unsubstituted or substituted organic radical selected from the group consisting of alkyl, cycloalkyl, aryl, and alkaryl radicals having 4 to 18 carbon atoms.

9. A method for increasing the pinholing limit and/or for reducing the pinhole count in an aqueous pigmented coating, comprising adding to an aqueous pigmented coating, at least one vinyl ether of the general formula R—O—CH═CH₂, where R is an unsubstituted or substituted organic radical selected from the group consisting of alkyl, cycloalkyl, aryl, and alkaryl radicals having 4 to 18 carbon atoms.
